(19) United States
(12) Patent Application Publication
(10) Pub. No.: US 2025/0136803 A1
(43) Pub. Date: May 1, 2025

(54) HYDROPHOBIC PVA COMPOSITE OBJECT HAVING GRAPHENE-BASED MATERIALS AND MANUFACTURING METHOD FOR THE SAME

(71) Applicant: Green Package Solution Co., Ltd, Gumi-si (KR)

(72) Inventor: Sung Hun AHN, Yongin-si (KR)

(73) Assignee: Green Package Solution Co., Ltd, Gumi-si (KR)

(21) Appl. No.: 18/520,663

(22) Filed: Nov. 28, 2023

(30) Foreign Application Priority Data
Oct. 31, 2023 (KR) 10-2023-0147574

(51) Int. Cl. C08L 29/04; C08K 3/04; C08K 7/02

(52) U.S. Cl. CPC C08L 29/04; C08K 3/042; C08K 7/02; C08K 2201/011; C08L 2201/06; C08L 2205/16

(57) ABSTRACT

The present disclosure relates to a PVA composite object having improved hydrophobicity and a method for manufacturing the same, wherein an embodiment of the present disclosure relates to a PVA composite object having biodegradability, which has excellent oxygen blocking properties and vapor blocking properties and is capable of being utilized as packaging containers for food or packaging films. The PVA composite object according to an embodiment of the present disclosure includes PVA, polyacrylic acid (PAA), and a graphene-based material. The graphene-based material is at least one among graphene oxide (GO) and reduced graphene oxide (rGO). An embodiment may further include a cellulose nano fiber (CNF).

### CROSS-REFERENCE TO RELATED APPLICATION

This application claims priority to Korean Patent Application No. 10-2023-0147574 filed on Oct. 31, 2023 and all the benefits accruing therefrom under 35 U.S.C. § 119, the contents of which are incorporated by reference in their entirety.

### BACKGROUND

The present disclosure herein relates to a PVA composite object having improved hydrophobicity and a method for manufacturing the same. An embodiment of the present disclosure relates to a PVA composite object having biodegradability, which has excellent oxygen blocking properties and vapor blocking properties and is capable of being utilized as packaging containers for food or packaging films.

Polyvinyl alcohol (PVA) is a water-soluble polymer and is known as a biodegradable polymer. Due to the properties, the PVA is utilized as vascular stents and contact lenses as well as straws, packaging containers for food and packaging films, which require biodegradability.

However, the PVA has the degree of swelling of 104.8% and a water contact angle of 22.52° and is weak to water, and accordingly, there are difficulties in utilizing as straws or packaging containers for food.

A prior art discloses a biodegradable resin composition having improved biodegradability by mixing PVA, PE or the like.

### SUMMARY

An object of the present disclosure is to provide a PVA composite object having improved hydrophobicity and a method for manufacturing the same.

In addition, the PVA composite object manufactured by the present disclosure has excellent biodegradability.

In addition, the PVA composite object manufactured by the present disclosure has excellent oxygen blocking properties and moisture blocking properties.

A polyvinyl alcohol (PVA) composite object according to the present disclosure includes: PVA: polyacrylic acid (PAA); and a graphene-based material. The graphene-based material is at least one among graphene oxide (GO) and reduced graphene oxide (rGO). In an embodiment, a cellulose nano fiber (CNF) may be further included.

The content of the PAA may be from 20 to 30 parts by weight on the basis of 100 parts by weight of the PVA.

The content of the graphene-based material may be from 0.1 to 0.5 parts by weight on the basis of 100 parts by weight of the PVA.

The content of the CNF may be from 0.1 to 0.3 parts by weight on the basis of 100 parts by weight of the PVA.

A method for manufacturing a polyvinyl alcohol (PVA) composite object according to an embodiment of the present disclosure includes: mixing PVA and a first solvent to prepare a first mixture; mixing the first mixture with polyacrylic acid (PAA) and a second solvent to prepare a second mixture; and mixing the first mixture, the second mixture and a graphene-based material to prepare a third mixture.

The preparing of the first mixture may include mixing the PVA and the first solvent to prepare a PVA solution, heating the PVA solution to 70 to 90° C., and cooling the PVA solution to 20 to 30° C.

### BRIEF DESCRIPTION OF THE FIGURES

The accompanying drawing is included to provide a further understanding of the inventive concept and is incorporated in and constitutes a part of this specification. The drawing illustrates an embodiment of the inventive concept and, together with the description, serves to explain principles of the inventive concept. In the drawing:

FIG. 1 is a flowchart of a method for manufacturing a PVA composite object according to an embodiment of the inventive concept.

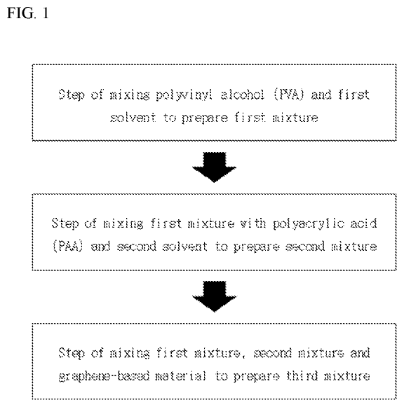

### DETAILED DESCRIPTION

Hereinafter, preferred embodiments of the inventive concept will be explained with reference to the accompany drawing. The inventive concept may, however, be embodied in various forms and should not be construed as limited to the embodiments set forth herein. In addition, the embodiments are provided to completely inform a person having ordinary knowledge in this technical field to which the inventive concept belongs of the scope of the inventive concept.

The polyvinyl alcohol (PVA) composite object according to an embodiment of the present disclosure includes polyvinyl alcohol (PVA), polyacrylic acid (PAA) and a graphene-based material. The graphene-based material is at least one among graphene oxide (GO) and reduced graphene oxide (rGO). An embodiment may further include a cellulose nano fiber (CNF).

The polyvinyl alcohol (PVA) may be represented by Formula 1 below.

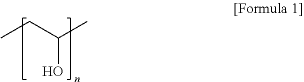

(where n is a natural number)

The polyacrylic acid (PAA) may be represented by Formula 2 below.

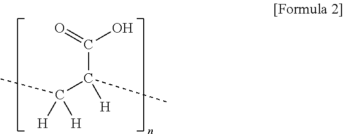

(where n is a natural number)

In the present disclosure, by mixing polyvinyl alcohol with polyacrylic acid, a water contact angle may increase and surface energy may be reduced. The molecular weight (Mw) of the polyacrylic acid may be from 100,000 to 500,000, preferably, 250,000. If the molecular weight is too small, moisture permeability may increase, and there may be defects of reducing moisture blocking properties. On the contrary, if the molecular weight is too large, solubility of the polyacrylic acid in the solvent is significantly reduced, and there are defects of not dissolving in the solvent.

The content of the polyacrylic acid may be from 10 to 40 parts by weight, preferably, from 20 to 30 parts by weight, more preferably, from 23 to 27 parts by weight on the basis of 100 parts by weight of the polyvinyl alcohol. If the content of the polyacrylic acid is too small, the degree of crosslinking is reduced, and there are defects of increasing the degree of swelling, and if the content is too large, there are defects in that a biodegrading rate is reduced, the PVA content is reduced, and oxygen permeability increases.

The polyvinyl alcohol and the polyacrylic acid are combined via a crosslinking reaction by a mixing process, which will be explained later to play the role of a structure forming the shape of a packaging container, a film or the like.

The graphene oxide (GO) corresponds to particles having an average particle diameter of several to tens of micrometers, which may be uniformly dispersed and disposed in the structure composed of the polyvinyl alcohol and the polyacrylic acid. By adding the graphene oxide, both oxygen permeability and vapor permeability may be improved.

The content of the graphene oxide may be from 0.1 to 0.5 parts by weight, preferably, from 0.1 to 0.2 parts by weight on the basis of 100 parts by weight of the polyvinyl alcohol. If the content of the graphene oxide is too large, the crosslinking reaction of the polyvinyl alcohol and the polyacrylic acid may be inhibited, lumps may be formed, and there are defects of degrading the apparent quality and physical properties of a PVA composite object. If the content of the graphene oxide is too small, oxygen permeability and vapor permeability may not be improved.

The reduced graphene oxide (rGO) corresponds to particles having an average particle diameter of several to tens of micrometers, which may be uniformly dispersed and disposed in the structure composed of the polyvinyl alcohol and the polyacrylic acid. By adding the reduced graphene oxide, both oxygen permeability and vapor permeability may be improved.

The content of the reduced graphene oxide may be from 0.1 to 0.5 parts by weight, preferably, from 0.1 to 0.2 parts by weight on the basis of 100 parts by weight of the polyvinyl alcohol. If the content of the reduced graphene oxide is too large, the crosslinking reaction of the polyvinyl alcohol and the polyacrylic acid may be inhibited, lumps may be formed, and there are defects of degrading the apparent quality and physical properties of a PVA composite object. If the content of the reduced graphene oxide is too small, oxygen permeability and vapor permeability may not be improved.

The cellulose nano fiber (CNF) is a cellulose fiber having a size of nanometers. Generally, the cellulose nano fiber may be prepared by physically crushing vegetable materials such as timber and then nanosizing. The cellulose nano fiber may have a diameter of several to tens of nanometers and a length of several to tens of micrometers. By adding the cellulose nano fiber together with the graphene oxide, both oxygen permeability and vapor permeability may be improved.

The content of the cellulose nano fiber may be from 0.1 to 0.3 parts by weight on the basis of 100 parts by weight of the polyvinyl alcohol. If the content of the cellulose nano fiber is too large, the crosslinking reaction of the polyvinyl alcohol and the polyacrylic acid may be inhibited, lumps may be formed, and there are defects of degrading the apparent quality and physical properties of a PVA composite object. In addition, the cellulose nano fiber is hydrophilic and may absorb moisture in the air, thereby reducing the lifetime of a product. If the content of the cellulose nano fiber is too small, both oxygen permeability and vapor permeability may not be improved.

The method for manufacturing the PVA composite object according to an embodiment of the present disclosure includes: a step of mixing polyvinyl alcohol (PVA) and a first solvent to prepare a first mixture: a step of mixing the first mixture with polyacrylic acid (PAA) and a second solvent to prepare a second mixture; and a step of mixing the first mixture, the second mixture and a graphene-based material to prepare a third mixture. The graphene-based material is at least one among graphene oxide (GO) and reduced graphene oxide (rGO). An embodiment may further include at least one among a step of casting the third mixture or putting the third mixture in a mold to provide a shape, and a step of heating the third mixture.

In the step of preparing the first mixture, the polyvinyl alcohol is the same as explained above. The polyvinyl alcohol may use one in a powder type. The first solvent may be one dissolving the polyvinyl alcohol and may be de-ionized water.

This step may include a step of mixing the polyvinyl alcohol (PVA) and the first solvent to prepare a polyvinyl alcohol solution, a step of heating the polyvinyl alcohol solution to 70 to 90° C., and a step of cooling the polyvinyl alcohol to 20 to 30° C.

The step of preparing the polyvinyl alcohol solution may be carried out by adding the polyvinyl alcohol in a powder type to the first solvent. In this step, the weight ratio of the polyvinyl alcohol and the first solvent may be weight of polyvinyl alcohol:weight of first solvent of 1:10 to 1:15 by the weight. If the first solvent is too large, a process for forming a shape or a heating process may not be performed smoothly, and a defect ratio may increase, and if the first solvent is too small, there are defects in that the polyvinyl alcohol may be insufficiently dissolved.

After that, the polyvinyl alcohol may be heated so as to be dissolved in the first solvent. In this step, heating may be carried out at a temperature of less than 100° C., preferably, from 70 to 90° C., for 1 to 2 hours.

Then, the heated polyvinyl alcohol solution may be stood at room temperature or cooled using a chiller or the like to 20 to 30° C. This step is for preventing the non-uniform occurrence of a crosslinking reaction. If polyacrylic acid is injected at a high temperature, a crosslinking reaction may locally occur, and hydrophobicity may become inferior overall.

In the step of preparing the second mixture, the polyacrylic acid is the same as described above. The polyacrylic acid may be dissolved in de-ionized water and provided in a solution state. The second solvent may be one miscible with the polyacrylic acid (polyacrylic acid in a solution state) and may be de-ionized water.

This step may be carried out by adding the polyacrylic acid in a powder form to the second solvent. In this step, the weight ratio of the polyacrylic acid and the second solvent may be weight of polyacrylic acid:weight of second solvent of 1:8 to 1:12 by the weight. If the second solvent is too large, a process for forming a shape or a heating process may not be performed smoothly, and a defect ratio may increase, and if the second solvent is too small, the reaction of the polyacrylic acid and the polyvinyl alcohol may not occur well. This step may be carried out at room temperature (20 to 30° C.).

In the step for preparing the third mixture, the first mixture and the second mixture, prepared in advance, and graphene oxide or reduced graphene oxide are mixed. The graphene oxide and the reduced graphene oxide may be the same as described above. The graphene oxide and the reduced graphene oxide may be mixed in a powder state, or mixed in a dispersed state in a solvent such as de-ionized water.

This step may include a step of mixing the first mixture and the second mixture, and a step of adding a graphene-based material to the mixture of the first mixture and the second mixture. By mixing the first mixture and the second mixture prior to adding the graphene-based material, the polyvinyl alcohol and the polyacrylic acid may react even more stably.

The step of mixing the first mixture and the second mixture may be carried out by stirring at room temperature for 4 to 10 hours so that the polyvinyl alcohol and the polyacrylic acid may be sufficiently combined and uniformly dispersed.

The step of adding the graphene-based material may be carried out by adding a graphene-based material in a powder form or a dispersed state in a solvent and then, stirring. This step may be carried out at room temperature for 1 to 2 hours.

In addition, this step may further include a step of adding a cellulose nano fiber. The cellulose nano fiber may be added after mixing the first mixture and the second mixture, and may be added at the same time with or at different time from the graphene-based material.

In this step, the content of the polyacrylic acid may be from 20 to 30 parts by weight on the basis of 100 parts by weight of the polyvinyl alcohol, the content of the graphene-based material may be from 0.1 to 0.5 parts by weight, preferably, from 0.1 to 0.2 parts by weight on the basis of 100 parts by weight of the polyvinyl alcohol, and the content of the cellulose nano fiber may be from 0.1 to 0.3 parts by weight on the basis of 100 parts by weight of the polyvinyl alcohol.

The step for providing a shape to the third mixture is a step for providing a shape of a PVA composite object to be manufactured. If the PVA composite object is a container, a shape may be provided by pouring the third mixture in a mold having a container shape, and if the PVA composite object is a film, a shape may be provided by a casting method. This step may be performed by a general method for providing a shape in a field of manufacturing a product using a resin, without specific limitation.

In the step of heating the third mixture, the crosslinking reaction of the polyvinyl alcohol and the polyacrylic acid is completed for curing and for removing the solvents. This step may include a step of drying the third mixture, a step of heating the dried third mixture at a low temperature and a step of heating the heated third mixture at a low temperature, at a high temperature. By performing drying, heating at a low temperature and heating at a high temperature in order like this, the crosslinking reaction of the polyvinyl alcohol and the polyacrylic acid may be carried out in a uniform rate, and the surface quality of the PVA composite object may be kept excellent. The step for drying may be carried out at room temperature (20 to 30° C.) for 10 to 30 hours, and the heating at a low temperature may be carried out at less than 100° C., preferably, from 80 to 90° C. for 1 to 2 hours. The heating at a high temperature may be carried out at 150° C. or higher, preferably, from 165 to 175° C. for 1 to 2 hours.

### Example: Manufacture of PVA Composite Film

In order to manufacture a PVA composite film, polyvinyl alcohol of Thermo scientific Co. (degree of saponification of 98-99%), polyacrylic acid of Waco Chemical Co. (Mw of 250,000), graphene oxide and reduced graphene oxide of Grapheneall Co., Ltd. (solution state contained by 0.5 wt % in water), and a cellulose nano fiber of Hansol Paper Ltd. (solution state contained by 1 wt % in water) were used.

Example 1:20 g of polyvinyl alcohol was put in 250 g of de-ionized water and dissolved while stirring at 80° C. to prepare a polyvinyl alcohol solution. After dissolving all the polyvinyl alcohol, the temperature was slowly reduced to room temperature (25° C.). Then, 5 g of polyacrylic acid was put in 50 g of de-ionized water and dissolved while stirring at room temperature to prepare a polyacrylic acid solution. After that, the polyvinyl alcohol solution and the polyacrylic acid solution were mixed and stirred at room temperature for 4 hours. Then, 8 g of a graphene oxide solution (0.04 g of graphene oxide) was added thereto as a graphene-based material and stirred for 1 hour. After completing the stirring, the mixture was poured on a Teflon plate and dried for 24 hours to remove bubbles and the solvents. The dried mixture was put in an oven and heated at 90° C. for 2 hours and then, heated at 170° C. for 1 hour. After completing the heating, the mixture was cooled to room temperature to manufacture a PVA composite film.

Example 2: The same method as Example 1 was performed except for adding 8 g of a reduced graphene oxide solution (0.04 g of graphene oxide) instead of the graphene oxide solution as the graphene-based material.

Example 3: The same method as Example 1 was performed except for adding 4 g of a graphene oxide solution (0.02 g of graphene oxide) and 4 g of a reduced graphene oxide solution (0.02 g of graphene oxide) as the graphene-based materials.

Example 4: The same method as Example 1 was performed except for further adding 2 g of a cellulose nano fiber solution (0.02 g of cellulose nano fiber) together with the graphene-based material.

Example 5: The same method as Example 1 was performed except for adding 8 g of a reduced graphene oxide solution (0.04 g of graphene oxide) instead of the graphene oxide solution as the graphene-based material, and further adding 2 g of a cellulose nano fiber solution (0.02 g of cellulose nano fiber) together with the graphene-based material.

Comparative Example 1: The same method as Example 1 was performed except for not adding the graphene-based material.

### Experimental Example: Measurement of Oxygen Permeability

The oxygen permeability of the Examples and the Comparative Example was measured using OX-TRAN 2/21 and OX-TRAN 2/22 (H) (MOCON Co.).

### Experimental Example: Measurement of Vapor Permeability

The vapor permeability of the Examples and the Comparative Example was measured using PERMATRAN-W 3/33 and PERMATRAN-W 3/34 (H) (MOCON Co.). The Examples were measured at a relative humidity of 50%, and the Comparative Example was measured at a relative humidity of 40%.

The oxygen permeability and vapor permeability, measured in the Experimental Examples are shown in Table 1. The Examples including the graphene-based material showed markedly excellent oxygen permeability and vapor permeability in contrast to the Comparative Example. The oxygen permeability was good in the order of Example 5, Example 4, Example 3, Example 1 and Example 2, and the vapor permeability was good in the order of Example 5, Example 1, Example 2, Example 4 and Example 3. Through the Experimental Examples, it can be found that the oxygen permeability and vapor permeability can be improved by adding the reduced graphene oxide together with the cellulose nano fiber.

TABLE 1

| | Division | | | | | | |
|---|---|---|---|---|---|---|---|
| | PVA | PAA | GO | rGO | CNF | Oxygen | Vapor |
| | content | content | content | content | content | permeability | permeability |
| | (g) | (g) | (g) | (g) | (g) | (cc/(m² · day)) | (g/(m² · atom · day)) |
| Example 1 | 20 | 5 | 0.04 | 0 | 0 | 0.0086 | 0.0131 |
| Example 2 | 20 | 5 | 0 | 0.04 | 0 | 0.0242 | 0.0174 |
| Example 3 | 20 | 5 | 0.02 | 0.02 | 0 | 0.0067 | 0.0282 |
| Example 4 | 20 | 5 | 0.04 | 0 | 0.02 | 0.0052 | 0.0292 |
| Example 5 | 20 | 5 | 0 | 0.04 | 0.02 | 0.0003 | 0.0017 |
| Comparative | 20 | 5 | 0 | 0 | 0 | 0.5 | 0.46 |
| Example 1 | | | | | | | |

The PVA composite object according to an embodiment of the present disclosure and a method for manufacturing the same show excellent hydrophobicity.

In addition, the PVA composite object manufactured by the present disclosure has excellent biodegradability.

In addition, the PVA composite object manufactured by the present disclosure has excellent oxygen blocking properties and moisture blocking properties.

Although the embodiments of the present invention have been described, it is understood that the present invention should not be limited to these embodiments, but various changes and modifications can be made by one ordinary skilled in the art within the spirit and scope of the present invention as hereinafter claimed.

What is claimed is:

1. A polyvinyl alcohol (PVA) composite object comprising:
PVA;
polyacrylic acid (PAA); and
a graphene-based material,
wherein the graphene-based material is at least one among graphene oxide (GO) and reduced graphene oxide (rGO).

2. The PVA composite object of claim 1, wherein the content of the PAA is from 20 to 30 parts by weight on the basis of 100 parts by weight of the PVA.

3. The PVA composite object of claim 1, wherein the content of the at least one among the graphene oxide and the reduced graphene oxide is from 0.1 to 0.5 parts by weight on the basis of 100 parts by weight of the PVA.

4. The PVA composite object of claim 1, further comprising a cellulose nano fiber (CNF).

5. The PVA composite object of claim 4, wherein the content of the CNF is from 0.1 to 0.3 parts by weight on the basis of 100 parts by weight of the PVA.

6. A method for manufacturing a polyvinyl alcohol (PVA) composite object, the method comprising:
mixing PVA and a first solvent to prepare a first mixture;
mixing the first mixture with polyacrylic acid (PAA) and a second solvent to prepare a second mixture; and
mixing the first mixture, the second mixture and a graphene-based material to prepare a third mixture,
wherein the graphene-based material is at least one among graphene oxide (GO) and reduced graphene oxide (rGO).

7. The method for manufacturing a PVA composite object of claim 6, wherein the preparing of the first mixture comprises:
mixing the PVA and the first solvent to prepare a PVA solution;
heating the PVA solution to 70 to 90° C.; and
cooling the PVA solution to 20 to 30° C.
